(19) United States
(12) Patent Application Publication
(10) Pub. No.: US 2024/0176590 A1
(43) Pub. Date: May 30, 2024

(54) MULTIPLY-ACCUMULATE OPERATION METHOD AND APPARATUS

(71) Applicant: ELECTRONICS AND TELECOMMUNICATIONS RESEARCH INSTITUTE, Daejeon (KR)

(72) Inventor: Jin-Ho HAN, Daejeon (KR)

(21) Appl. No.: 18/522,797

(22) Filed: Nov. 29, 2023

(30) Foreign Application Priority Data
Nov. 29, 2022 (KR) 10-2022-0163049
Mar. 24, 2023 (KR) 10-2023-0038830

(51) Int. Cl. G06F 7/544; G06F 5/01; G06F 7/483

(52) U.S. Cl. CPC G06F 7/5443; G06F 5/01; G06F 7/483

(57) ABSTRACT

An embodiment of the present disclosure may provide a multiply-accumulate operation method performed by a multiply-accumulate operation apparatus, the multiply-accumulate operation method including accumulating, by an accumulation register, a value within a preset bit value of a mantissa bitwidth in a result of an addition operation of a shifted first mantissa value and a shifted second mantissa value, determining, by an overflow counter, an overflow count based on an overflow value by which the result of the addition operation of the shifted first mantissa value and the shifted second mantissa value exceeds the preset bit value of the mantissa bitwidth, performing normalization and rounding based on the value accumulated in the accumulation register and the overflow count, and updating, by an exponent updater, the exponent using a normalized and rounded value.

### CROSS REFERENCE TO RELATED APPLICATIONS

This application claims the benefit of Korean Patent Application Nos. 10-2022-0163049, filed Nov. 29, 2022 and 10-2023-0038830, filed Mar. 24, 2023, which are hereby incorporated by reference in their entireties into this application.

### BACKGROUND OF THE INVENTION

### 1. Technical Field

The present disclosure relates to floating-point Multiply-Accumulate (MAC) operation technology for low-power artificial neural network computations.

### 2. Description of the Related Art

Generally, for artificial neural network processing in various fields, an Artificial Intelligence (AI) processor having high power efficiency is required. For this, an artificial intelligence processor to which nonvolatile memory-based Processing-In-Memory (PIM) architecture is applied has been developed.

Because such an artificial intelligence processor generally supports only operations of 8-bit fixed-point data type, research into an operation scheme using a floating-point data type using the artificial intelligence processor is required, and floating-point operations are problematic in great complication and high-power consumption.

Meanwhile, Korean Patent Application Publication No. 10-2022-0156268 entitled “Artificial Intelligence Accelerator” discloses an artificial intelligence accelerator which performs an accumulation operation.

### SUMMARY OF THE INVENTION

An object of the present disclosure is to provide a floating-point multiply-accumulate operation with high power efficiency at very low power.

Another object of the present disclosure is to provide high computational efficiency to an artificial intelligence processor through the floating-point multiply-accumulation operation.

In accordance with an embodiment to accomplish the above objects, there is provided a multiply-accumulate operation method performed by a multiply-accumulate operation apparatus, the multiply-accumulate operation method including calculating, by an exponent subtractor, a difference between a value, obtained by adding a first exponent and a second exponent using an exponent adder, and an exponent of a floating-point value to be added, calculating, by a mantissa multiplier, a value obtained by multiplying a first mantissa by a second mantissa, shifting, by a mantissa shifter, at least one of the value, which is obtained by multiplying the first mantissa by the second mantissa, and a mantissa value of the floating point value to be added, by the difference, adding, by a mantissa adder, a shifted first mantissa value and a shifted second mantissa value to each other, accumulating, by an accumulation register, a value within a preset bit value of a mantissa bitwidth in a result of an addition operation of the shifted first mantissa value and the shifted second mantissa value, determining, by an overflow counter, an overflow count based on an overflow value by which the result of the addition operation of the shifted first mantissa value and the shifted second mantissa value exceeds the preset bit value of the mantissa bitwidth, performing normalization and rounding based on the value accumulated in the accumulation register and the overflow count, and updating, by an exponent updater, the exponent using a normalized and rounded value.

The multiply-accumulate operation apparatus may include a Magnetoresistive Random Access Memory Computing-In-Memory (MRAM-CIM) core and a high precision neural core.

Operations performed by the exponent adder, the mantissa multiplier, the exponent subtractor, the mantissa shifter, the mantissa adder, and the overflow counter may be performed in the MRAM-CIM core.

The operation of the exponent adder may be performed in Cell_0 of the MRAM-CIM core.

The operation of the mantissa multiplier may be performed in Cell_1 of the MRAM-CIM core.

Operations performed by the exponent subtractor, the mantissa shifter, the mantissa adder, and the overflow counter may be performed in a Neural Functional Unit (NFU) and a Special Function Unit (SFU) of the MRAM-CIM core.

The normalization and rounding operation may be performed in the high precision neural core.

Here, the preset bit value of the mantissa bitwidth may be set in advance to an arbitrary bit value for a floating-point operation.

Here, the accumulating may include accumulating a value in which the result of the addition operation falls within the preset bit value of the mantissa bitwidth.

Here, the determining may include storing the overflow value by which the result of the addition operation exceeds the preset bit value of the mantissa bitwidth, and increasing the overflow count by the overflow value.

Further, in accordance with an embodiment to accomplish the above objects, there is provided a multiply-accumulate operation apparatus, including memory configured to store a control program for a multiply-accumulate operation, and a processor configured to execute the control program stored in the memory, wherein the processor is configured to perform control to calculate, by an exponent subtractor, a difference between a value, obtained by adding a first exponent and a second exponent using an exponent adder, and an exponent of a floating-point value to be added, perform control to calculate, by a mantissa multiplier, a value obtained by multiplying a first mantissa by a second mantissa, perform control to shift, by a mantissa shifter, at least one of the value, which is obtained by multiplying the first mantissa by the second mantissa, and a mantissa value of the floating point value to be added, by the difference, perform control to add, by a mantissa adder, a shifted first mantissa value and a shifted second mantissa value to each other, perform control to accumulate, by an accumulation register, a value within a preset bit value of a mantissa bitwidth in a result of an addition operation of the shifted first mantissa value and the shifted second mantissa value, perform control to determine, by an overflow counter, an overflow count based on an overflow value by which the result of the addition operation of the shifted first mantissa value and the shifted second mantissa value exceeds the preset bit value of the mantissa bitwidth, perform control to perform normalization and rounding based on the value accumulated in the accumulation register and the overflow count, and perform control to update, by an exponent updater, the exponent using a normalized and rounded value.

The processor may be configured to perform control such that operations performed by the exponent adder, the mantissa multiplier, the exponent subtractor, the mantissa shifter, the mantissa adder, and the overflow counter are performed in a Magnetoresistive Random Access Memory Computing-In-Memory (MRAM-CIM) core.

The processor may be configured to perform control such that the operation of the exponent adder is performed in Cell_0 of the MRAM-CIM core.

The processor may be configured to perform control such that the operation of the mantissa multiplier is performed in Cell_1 of the MRAM-CIM core.

The processor may be configured to perform control such that operations performed by the exponent subtractor, the mantissa shifter, the mantissa adder, and the overflow counter are performed in a Neural Functional Unit (NFU) and a Special Function Unit (SFU) of the MRAM-CIM core.

The processor may be configured to perform control such that the normalization and rounding operation is performed in the high precision neural core.

Here, the preset bit value of the mantissa bitwidth may be set in advance to an arbitrary bit value for a floating-point operation.

Here, the processor may be configured to accumulate a value in which the result of the addition operation falls within the preset bit value of the mantissa bitwidth.

Here, the processor may be configured to store the overflow value by which the result of the addition operation exceeds the preset bit value of the mantissa bitwidth and to increase the overflow count by the overflow value.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a multiply-accumulate operation apparatus according to an embodiment of the present disclosure;

FIG. 2 is a block diagram illustrating the detailed configuration of a multiply-accumulate operation apparatus according to an embodiment of the present disclosure;

FIG. 3 is a block diagram illustrating the operation of a multiply-accumulate operation apparatus according to an embodiment of the present disclosure;

FIG. 4 is a block diagram illustrating a multiply-accumulate operation apparatus according to an embodiment of the present disclosure;

FIG. 5 is an operation flowchart illustrating a multiply-accumulate operation method according to an embodiment of the present disclosure; and

FIG. 6 is a block diagram illustrating the configuration of a computer system according to an embodiment of the present disclosure.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will now be described in detail with reference to the accompanying drawings, identical reference numerals are assigned to indicate identical or corresponding elements in descriptions made with reference to the drawings, and overlapping descriptions will be omitted.

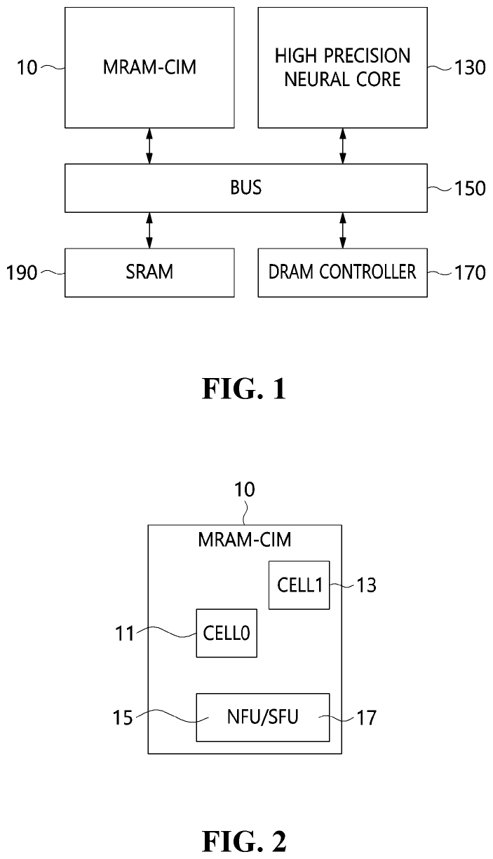

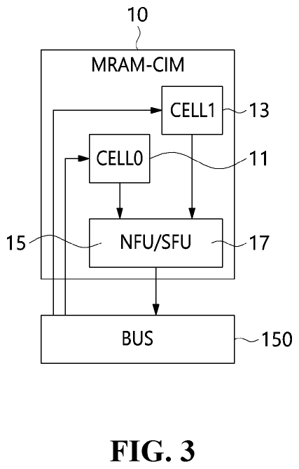

FIG. 1 is a block diagram illustrating a multiply-accumulate operation apparatus according to an embodiment of the present disclosure, FIG. 2 is a block diagram illustrating the detailed configuration of a multiply-accumulate operation apparatus according to an embodiment of the present disclosure, and FIG. 3 is a block diagram illustrating the operation of a multiply-accumulate operation apparatus according to an embodiment of the present disclosure.

Referring to FIG. 1, the multiply-accumulate operation apparatus according to the embodiment may include a Magnetoresistive Random Access Memory Computing-In-Memory (MRAM-CIM) core 10, a high precision neural core 130, a bus 150, a Dynamic RAM (DRAM) controller 170, and Static RAM (SRAM)190.

As illustrated in FIG. 2, the MRAM-CIM core 10 may include MRAM cells Cell_0 11 and Cell_1 13, a Neural Functional Unit (NFU) 15/Special Function Unit (SFU) 17.

Referring back to FIG. 1, the high precision neural core 130 may support high-precision operations.

The bus 150 may provide a path so that the MRAM-CIM core 10 and the high precision neural core 130 perform communication with the DRAM controller 170 and the SRAM 190. Here, the SRAM 190 may have an on-chip memory structure.

The multiply-accumulate operation apparatus may be connected to external memory through the DRAM controller 170 and the SRAM 190.

As illustrated in FIG. 3, Cell_0 11 and Cell_1 13 may receive signals through the bus 150, and may then provide the signals to the NFU 115/SFU 17.

Hereinafter, a process of performing operations using the multiply-accumulate operation apparatus will be described.

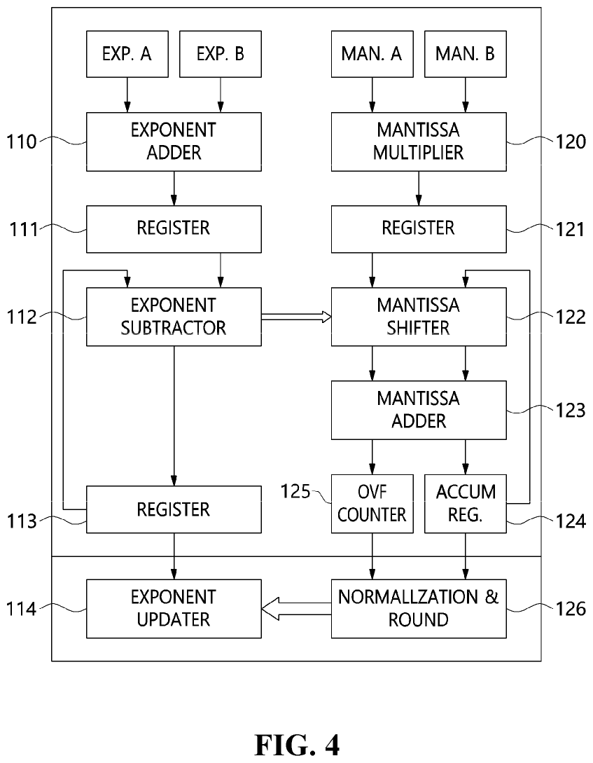

FIG. 4 is a block diagram illustrating a multiply-accumulate operation apparatus according to an embodiment of the present disclosure.

Referring to FIG. 4, the multiply-accumulate operation apparatus according to the embodiment of the present disclosure includes an exponent adder 110, a first exponent register 111, an exponent subtractor 112, a second exponent register 113, a mantissa multiplier 120, a first mantissa register 121, a mantissa shifter 122, a mantissa adder 123, an accumulation register 124, an overflow counter 125, and a normalizer 126.

The first exponent register 111 may store the result of performing an addition operation on a first exponent Exp. A and a second exponent Exp. B.

The exponent subtractor 112 may perform a subtraction operation of calculating a difference between on the addition operation result and the exponent of a floating-point value to be added.

The second exponent register 113 may store the result of the subtraction operation.

The mantissa multiplier 120 may perform a multiplication operation on a first mantissa Man. A and a second mantissa Man. B.

The first mantissa register 121 may store the result of the multiplication operation of the first mantissa and the second mantissa.

The mantissa shifter 122 may shift the value, obtained by multiplying the first mantissa by the second mantissa, or the mantissa value of the floating-point value to be added, by the difference value depending on the subtraction operation, received from the exponent subtractor.

The mantissa adder 123 may perform an addition operation on a shifted first mantissa value and a shifted second mantissa value.

The accumulation register (Accum Reg) 124 may accumulate a value within a preset mantissa bitwidth in the result of the addition operation of the shifted first mantissa value and the shifted second mantissa value.

Here, the accumulation register 124 may accumulate a value in which the result of the addition operation falls within 2 bits of the mantissa bitwidth.

The bit value of the mantissa bitwidth may be set in advance to an arbitrary bit value to perform a floating-point operation.

Here, the arbitrary bit value may support up to 8 bits, and description will be made based on 2 bits in an embodiment of the present disclosure.

In this case, the accumulation register 124 may accumulate the value in which the result of the addition operation falls within 2 bits of the mantissa bitwidth.

The overflow counter (Ovf Counter) 125 may determine the number of times an overflow occurs (an overflow count) based on an operation value obtained by performing the addition operation by the mantissa adder.

Here, the overflow counter 125 may store an overflow value by which the result of the addition operation exceeds 2 bits, which is an example of the preset value of the mantissa bitwidth, and may increase the overflow count by the overflow value.

The normalizer (Normalization & Round) 126 may perform normalization and rounding based on the value accumulated in the accumulation register and the overflow count determined by the overflow counter.

Here, the normalizer 126 may transfer the normalized and rounded value to an exponent updater 114.

Finally, the exponent updater 114 may change the exponent using the subtraction operation result stored in the second exponent register and the normalized and rounded value.

For example, the exponent updater 114 may reduce errors in result values by performing an exponent update only on partial MAC results, which are multiplied and accumulated for values within 2 bits of the mantissa bitwidth, through normalization and rounding, during 1000 floating-point Multiply-Accumulate (MAC) operations.

For example, assuming that 256 MAC operations are partial MAC operations and a total of 1000 MAC operations are performed, exponent update occurs only four times other than 1000 times.

Here, more specifically, the multiply-accumulate operation apparatus may perform a multiply-accumulate operation in the MRAM-CIM core 110 and the high precision neural core 130, which are MRAM-CIM-based artificial intelligence processors.

The operations performed by the exponent adder 110, the mantissa multiplier 120, the exponent subtractor 112, the mantissa shifter 122, the mantissa adder 123, and the overflow counter 125 may be performed in the MRAM-CIM core 110.

The operation of the exponent adder 110 may be performed in Cell_0 111 of the MRAM-CIM core 110. The operation of the mantissa multiplier 120 may be performed in Cell_1 113 of the MRAM-CIM core 110. The operations performed by the exponent subtractor 112, the mantissa shifter 122, the mantissa adder 123, and the overflow counter 125 may be performed in the Neural Functional Unit (NFU) 115 and the Special Function Unit (SFU) 117 of the MRAM-CIM core 110.

Meanwhile, the normalization and rounding operation of the normalizer 126 may be performed in the high precision neural core 130.

The high-precision neural core 130 may support a floating-point 16-bit data type or higher so as to process the normalization and rounding operation without the loss of accuracy.

In this case, the high precision neural core 130 may correspond to a processor core including a normalization and rounding operation unit.

Here, the high precision neural core 130 may process the normalization and rounding operation using the results of the exponent adder 110, the mantissa multiplier 120, the exponent subtractor 112, the mantissa shifter 122, the mantissa adder 123, and the overflow counter 125, calculated in the MRAM-CIM core.

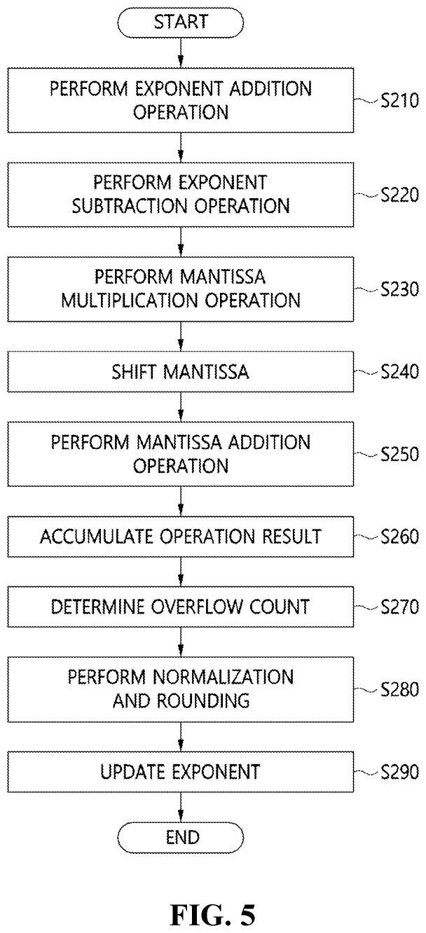

FIG. 5 is an operation flowchart illustrating a multiply-accumulate operation method according to an embodiment of the present disclosure.

Referring to FIG. 5, the exponent adder may perform an addition operation on a first exponent and a second exponent at step S210.

Here, at step S210, the first exponent register 111 may store the result of performing an addition operation on a first exponent Exp. A and a second exponent Exp. B.

The exponent subtractor 112 may perform a subtraction operation of calculating a difference between on the addition operation result and the exponent of a floating-point value to be added at step S220.

Here, at step S220, the second exponent register 113 may store the result of the subtraction operation.

The mantissa multiplier 120 may perform a multiplication operation on a first mantissa Man. A and a second mantissa Man. B at step S230.

Here, at step S230, the first mantissa register 121 may store the result of the multiplication operation of the first mantissa and the second mantissa.

The mantissa shifter 122 may shift the value, obtained by multiplying the first mantissa by the second mantissa, or the mantissa value of the floating-point value to be added, by the difference value depending on the subtraction operation, received from the exponent subtractor at step S240.

The mantissa adder 123 may perform an addition operation on a shifted first mantissa value and a shifted second mantissa value at step S250.

The accumulation register (Accum Reg) 124 may accumulate a value within a preset mantissa bitwidth in the result of the addition operation of the shifted first mantissa value and the shifted second mantissa value at step S260.

Here, at step S260, the accumulation register 124 may accumulate a value in which the result of the addition operation falls within 2 bits of the mantissa bitwidth.

The bit value of the mantissa bitwidth may be set in advance to an arbitrary bit value to perform a floating-point operation.

Here, the arbitrary bit value may support up to 8 bits, and description will be made based on 2 bits in an embodiment of the present disclosure.

In this case, at step S260, the accumulation register 124 may accumulate the value in which the result of the addition operation falls within 2 bits of the mantissa bitwidth.

The overflow counter (Ovf Counter) 125 may determine the number of times an overflow occurs (an overflow count) based on an operation value obtained by performing the addition operation by the mantissa adder at step S270.

Here, at step S270, the overflow counter 125 may store an overflow value by which the result of the addition operation exceeds 2 bits, which is an example of the preset value of the mantissa bitwidth, and may increase the overflow count by the overflow value.

The normalizer (Normalization & Round) 126 may perform normalization and rounding based on the value accumulated in the accumulation register and the overflow count determined by the overflow counter at step S280.

Here, at step S280, the normalizer 126 may transfer the normalized and rounded value to an exponent updater 114.

Finally, the exponent updater 114 may change the exponent using the subtraction operation result stored in the second exponent register and the normalized and rounded value at step S290.

For example, at step S290, the exponent updater 114 may reduce errors in result values by performing an exponent update only on partial MAC results, which are multiplied and accumulated for values within 2 bits of the mantissa bitwidth, through normalization and rounding, during 1000 floating-point multiply-accumulate operations (MAC).

For example, assuming that 256 MAC operations are partial MAC operations and a total of 1000 MAC operations are performed, exponent update occurs only four times other than 1000 times.

The multiply-accumulate operation apparatus and method according to embodiments of the present disclosure may perform a floating-point multiply-accumulate operation with high power efficiency at very low power.

The multiply-accumulate operation apparatus and method according to embodiments of the present disclosure may be implemented in a computer system such as a computer-readable storage medium.

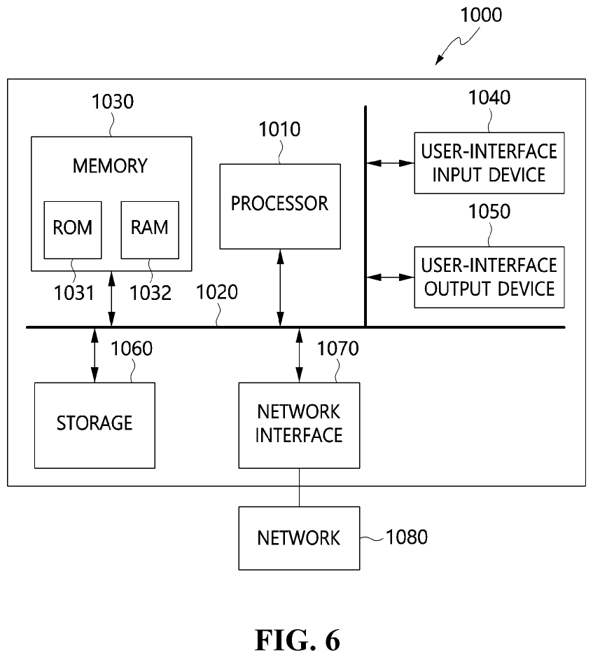

FIG. 6 is a block diagram illustrating the configuration of a computer system according to an embodiment of the present disclosure.

Referring to FIG. 6, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the multiply-accumulate operation apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing a multiply-accumulate operation method according to an embodiment. In detail, the memory 1030 may store multiple applications executed by the multiply-accumulate operation apparatus, and data and instructions for the operation of the multiply-accumulate operation apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, there can be provided a computer-readable storage medium for storing a computer program, which may include instructions enabling the processor to perform a method including an operation of calculating, by an exponent subtractor, a difference between a value, obtained by adding a first exponent and a second exponent using an exponent adder, and an exponent of a floating-point value to be added, an operation of calculating, by a mantissa multiplier, a value obtained by multiplying a first mantissa by a second mantissa, an operation of shifting, by a mantissa shifter, at least one of the value, which is obtained by multiplying the first mantissa by the second mantissa, and a mantissa value of the floating point value to be added, by the difference, an operation of adding, by a mantissa adder, a shifted first mantissa value and a shifted second mantissa value to each other, an operation of accumulating, by an accumulation register, a value within a preset bit value of a mantissa bitwidth in a result of an addition operation of the shifted first mantissa value and the shifted second mantissa value, an operation of determining, by an overflow counter, an overflow count based on an overflow value by which the result of the addition operation of the shifted first mantissa value and the shifted second mantissa value exceeds the preset bit value of the mantissa bitwidth, an operation of performing normalization and rounding based on the value accumulated in the accumulation register and the overflow count, and an operation of updating, by an exponent updater, the exponent using a normalized and rounded value.

In accordance with an embodiment, there can be provided a computer program stored in a computer-readable storage medium, which may include instructions enabling the processor to perform a method including an operation of calculating, by an exponent subtractor, a difference between a value, obtained by adding a first exponent and a second exponent using an exponent adder, and an exponent of a floating-point value to be added, an operation of calculating, by a mantissa multiplier, a value obtained by multiplying a first mantissa by a second mantissa, an operation of shifting, by a mantissa shifter, at least one of the value, which is obtained by multiplying the first mantissa by the second mantissa, and a mantissa value of the floating point value to be added, by the difference, an operation of adding, by a mantissa adder, a shifted first mantissa value and a shifted second mantissa value to each other, an operation of accumulating, by an accumulation register, a value within a preset bit value of a mantissa bitwidth in a result of an addition operation of the shifted first mantissa value and the shifted second mantissa value, an operation of determining, by an overflow counter, an overflow count based on an overflow value by which the result of the addition operation of the shifted first mantissa value and the shifted second mantissa value exceeds the preset bit value of the mantissa bitwidth, an operation of performing normalization and rounding based on the value accumulated in the accumulation register and the overflow count, and an operation of updating, by an exponent updater, the exponent using a normalized and rounded value.

The present disclosure may provide a floating-point multiply-accumulate operation with high power efficiency at very low power.

Further, the present disclosure may provide high computational efficiency to an artificial intelligence processor through the floating-point multiply-accumulation operation.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A multiply-accumulate operation method performed by a multiply-accumulate operation apparatus, the multiply-accumulate operation method comprising:
calculating, by an exponent subtractor, a difference between a value, obtained by adding a first exponent and a second exponent using an exponent adder, and an exponent of a floating-point value to be added;
calculating, by a mantissa multiplier, a value obtained by multiplying a first mantissa by a second mantissa;
shifting, by a mantissa shifter, at least one of the value, which is obtained by multiplying the first mantissa by the second mantissa, and a mantissa value of the floating point value to be added, by the difference;
adding, by a mantissa adder, a shifted first mantissa value and a shifted second mantissa value to each other;
accumulating, by an accumulation register, a value within a preset bit value of a mantissa bitwidth in a result of an addition operation of the shifted first mantissa value and the shifted second mantissa value;
determining, by an overflow counter, an overflow count based on an overflow value by which the result of the addition operation of the shifted first mantissa value and the shifted second mantissa value exceeds the preset bit value of the mantissa bitwidth;
performing normalization and rounding based on the value accumulated in the accumulation register and the overflow count; and
updating, by an exponent updater, the exponent using a normalized and rounded value.

2. The multiply-accumulate operation method of claim 1, wherein the multiply-accumulate operation apparatus comprises a Magnetoresistive Random Access Memory Computing-In-Memory (MRAM-CIM) core and a high precision neural core.

3. The multiply-accumulate operation method of claim 2, wherein operations performed by the exponent adder, the mantissa multiplier, the exponent subtractor, the mantissa shifter, the mantissa adder, and the overflow counter are performed in the MRAM-CIM core.

4. The multiply-accumulate operation method of claim 3, wherein the operation of the exponent adder is performed in Cell_0 of the MRAM-CIM core.

5. The multiply-accumulate operation method of claim 3, wherein the operation of the mantissa multiplier is performed in Cell_1 of the MRAM-CIM core.

6. The multiply-accumulate operation method of claim 3, wherein operations performed by the exponent subtractor, the mantissa shifter, the mantissa adder, and the overflow counter are performed in a Neural Functional Unit (NFU) and a Special Function Unit (SFU) of the MRAM-CIM core.

7. The multiply-accumulate operation method of claim 2, wherein the normalization and rounding operation is performed in the high precision neural core.

8. The multiply-accumulate operation method of claim 7, wherein the preset bit value of the mantissa bitwidth is set in advance to an arbitrary bit value for a floating-point operation.

9. The multiply-accumulate operation method of claim 8, wherein the accumulating comprises:
accumulating a value in which the result of the addition operation falls within the preset bit value of the mantissa bitwidth.

10. The multiply-accumulate operation method of claim 9, wherein the determining comprises:
storing the overflow value by which the result of the addition operation exceeds the preset bit value of the mantissa bitwidth, and increasing the overflow count by the overflow value.

11. A multiply-accumulate operation apparatus, comprising:
a memory configured to store a control program for a multiply-accumulate operation; and
a processor configured to execute the control program stored in the memory,
wherein the processor is configured to perform control to calculate, by an exponent subtractor, a difference between a value, obtained by adding a first exponent and a second exponent using an exponent adder, and an exponent of a floating-point value to be added, perform control to calculate, by a mantissa multiplier, a value obtained by multiplying a first mantissa by a second mantissa, perform control to shift, by a mantissa shifter, at least one of the value, which is obtained by multiplying the first mantissa by the second mantissa, and a mantissa value of the floating point value to be added, by the difference, perform control to add, by a mantissa adder, a shifted first mantissa value and a shifted second mantissa value to each other, perform control to accumulate, by an accumulation register, a value within a preset bit value of a mantissa bitwidth in a result of an addition operation of the shifted first mantissa value and the shifted second mantissa value, perform control to determine, by an overflow counter, an overflow count based on an overflow value by which the result of the addition operation of the shifted first mantissa value and the shifted second mantissa value exceeds the preset bit value of the mantissa bitwidth, perform control to perform normalization and rounding based on the value accumulated in the accumulation register and the overflow count, and perform control to update, by an exponent updater, the exponent using a normalized and rounded value.

12. The multiply-accumulate operation apparatus of claim 11, wherein the processor is configured to perform control such that operations performed by the exponent adder, the mantissa multiplier, the exponent subtractor, the mantissa shifter, the mantissa adder, and the overflow counter are performed in a Magnetoresistive Random Access Memory Computing-In-Memory (MRAM-CIM) core.

13. The multiply-accumulate operation apparatus of claim 12, wherein the processor is configured to perform control such that the operation of the exponent adder is performed in Cell_0 of the MRAM-CIM core.

14. The multiply-accumulate operation apparatus of claim 12, wherein the processor is configured to perform control such that the operation of the mantissa multiplier is performed in Cell_1 of the MRAM-CIM core.

15. The multiply-accumulate operation apparatus of claim 12, wherein the processor is configured to perform control such that operations performed by the exponent subtractor, the mantissa shifter, the mantissa adder, and the overflow counter are performed in a Neural Functional Unit (NFU) and a Special Function Unit (SFU) of the MRAM-CIM core.

16. The multiply-accumulate operation apparatus of claim 11, wherein the processor is configured to perform control such that the normalization and rounding operation is performed in the high precision neural core.

17. The multiply-accumulate operation apparatus of claim 11, wherein the preset bit value of the mantissa bitwidth is set in advance to an arbitrary bit value for a floating-point operation.

18. The multiply-accumulate operation apparatus of claim 17, wherein the processor is configured to accumulate a value in which the result of the addition operation falls within the preset bit value of the mantissa bitwidth.

19. The multiply-accumulate operation apparatus of claim 18, wherein the processor is configured to store the overflow value by which the result of the addition operation exceeds the preset bit value of the mantissa bitwidth and to increase the overflow count by the overflow value.
